(19) United States
(12) Patent Application Publication
(10) Pub. No.: US 2019/0089085 A1
(43) Pub. Date: Mar. 21, 2019

(54) CONNECTOR CONNECTING STRUCTURE

(71) Applicant: FANUC CORPORATION, Yamanashi (JP)

(72) Inventor: Shingo Odauchi, Yamanashi-ken (JP)

(73) Assignee: FANUC CORPORATION, Yamanashi (JP)

(21) Appl. No.: 16/136,638

(22) Filed: Sep. 20, 2018

(30) Foreign Application Priority Data
Sep. 21, 2017 (JP) 2017-180890

(51) Int. Cl. H01R 13/24; H01R 13/629; H01R 12/71

(52) U.S. Cl. CPC H01R 13/2464; H01R 12/718; H01R 13/629

(57) ABSTRACT

In a connector connecting structure, when in each of a plurality of pairs-of-contacts a first contact is pressed against a second contact relatively in an approaching direction and thereby connected to the second contact, a reaction force occurs in the first contact and the second contact. In this case, of the plurality of pairs-of-contacts, at least one pair-of-contacts differs from another pair-of-contacts in position of the first contact with respect to the second contact in the approaching direction at which the reaction force exceeds a certain pressure.

### CROSS-REFERENCE TO RELATED APPLICATION

This application is based upon and claims the benefit of priority from Japanese Patent Application No. 2017-180890 filed on Sep. 21, 2017, the contents of which are incorporated herein by reference.

### BACKGROUND OF THE INVENTION

### Field of the Invention

The present invention relates to a connector connecting structure for connecting electronic components.

### Description of the Related Art

Japanese Laid-Open Patent Publication No. 2014-056646 discloses a connector in which there are alternately disposed two kinds of contacts whose effective fitting lengths differ. In addition, Japanese Laid-Open Patent Publication No. 2002-216914 discloses a card connector in which spring piece units are bent at different positions from each other, whereby contact pressures are made different.

### SUMMARY OF THE INVENTION

A connector connecting structure has a first connector and a second connector, and by the first connector being caused to relatively approach the second connector in a fixed direction (an approaching direction) and thereby being connected (fitted) to the second connector, electronic components are electrically connected. The first connector has a plurality of first contacts disposed in parallel along a direction perpendicular to the approaching direction, while the second connector has a plurality of second contacts disposed in parallel along a direction perpendicular to the approaching direction. By connecting (fitting together) the first connector and the second connector, the plurality of first contacts and the plurality of second contacts are respectively connected. In this case, by increasing a holding power during connection, of the plurality of first contacts and the plurality of second contacts, vibration resistance of the first connector and the second connector in a connected state can be improved.

However, when the first connector and the second connector are caused to approach each other along the approaching direction and thereby be fitted together, positions where the plurality of first contacts and the plurality of second contacts abut respectively against each other are the same position in relation to the approaching direction, and hence in the first connector and the second connector, a reaction force acting in an opposite direction to an inserting direction (the approaching direction) gets larger.

This kind of problem occurs also in a connector connecting structure by which a plurality of first connectors disposed on a first substrate and a plurality of second connectors disposed on a second substrate are respectively connected (fitted together).

Thus, an object of the present invention is to provide a connector connecting structure that by a simple configuration, is able to reduce a reaction force occurring during connection.

A first aspect of the present invention is a connector connecting structure including: a first support member configured to support a plurality of first contacts; and a second support member configured to support a plurality of second contacts. In the connector connecting structure, the plurality of first contacts and the plurality of second contacts are respectively connected by the first support member and the second support member being caused to approach each other in an approaching direction. Further, in a case that a pair of one of the first contacts and one of the second contacts that is connected to the one of the first contacts is defined as a pair-of-contacts, when in each of a plurality of pairs-of-contacts the first contact is pressed against the second contact relatively in the approaching direction and thereby connected to the second contact, a reaction force that acts along an opposite direction to the approaching direction occurs in the first contact and the second contact or in the first support member and the second contact. Further, of the plurality of pairs-of-contacts, at least one pair-of-contacts differs from another pair-of-contacts regarding a position of the first contact or the first support member with respect to the second contact in the approaching direction at which the reaction force exceeds a certain pressure.

A second aspect of the present invention is a connector connecting structure including: a first substrate with a plurality of first connectors being disposed thereon; and a second substrate with a plurality of second connectors being disposed thereon, the plurality of first connectors and the plurality of second connectors are respectively fitted together by the first substrate and the second substrate being caused to approach each other in an approaching direction. Further, in a case where a pair of one of the first connectors and one of the second connectors that is fitted with respect to the one of the first connectors is defined as a pair-of-connectors, when in each of a plurality of pairs-of-connectors the first connector is pressed against the second connector relatively in the approaching direction and thereby fitted with respect to the second connector, a reaction force that acts along an opposite direction to the approaching direction occurs in the first connector and the second connector. Further, of the plurality of pairs-of-connectors, at least one pair-of-connectors differs from another pair-of-connectors regarding a position of the first connector with respect to the second connector in the approaching direction at which the reaction force exceeds a certain pressure.

A third aspect of the present invention is a connector connecting structure including: a first substrate with a plurality of first connectors being disposed in parallel thereon; and a second substrate with a plurality of second connectors being disposed in parallel thereon, the plurality of first connectors and the plurality of second connectors are respectively fitted together by the first substrate and the second substrate being caused to approach each other in an approaching direction. Further, in a case where a pair of one of the first connectors and one of the second connectors that is fitted with respect to the one of the first connectors is defined as a pair-of-connectors, and a contact pressure when the first connector and the second connector are fitted together differs between two pairs-of-connectors, of a plurality of the pairs-of-connectors.

Due to the present invention, a reaction force occurring during connection can be reduced by a simple configuration.

The above and other objects, features, and advantages of the present invention will become more apparent from the following description when taken in conjunction with the accompanying drawings, in which preferred embodiments of the present invention are shown by way of illustrative example.

### BRIEF DESCRIPTION OF THE DRAWINGS

FIG. 1A is a side view of a connector connecting structure of a first embodiment, and FIG. 1B is a partial plan view of the connector connecting structure of FIG. 1A;

FIGS. 2A to 2C are conceptual diagrams illustrating states of one pair-of-contacts when a first connector and a second connector are connected;

FIG. 3 is a view showing a relationship of an insertion amount of the first connector with respect to the second connector, and a reaction force;

FIG. 4 is a conceptual diagram of a first modified example of the connector connecting structure of FIGS. 1A and 1B;

FIG. 5 is a partial plan view of a second modified example of the connector connecting structure of FIGS. 1A and 1B;

FIGS. 6A and 6B are conceptual diagrams illustrating states of one pair-of-contacts when a first connector and a second connector of FIG. 5 are connected;

FIGS. 7A and 7B are conceptual diagrams illustrating states of one pair-of-contacts when the first connector and the second connector of FIG. 5 are connected;

FIG. 8 is a partial plan view of a third modified example of the connector connecting structure of FIGS. 1A and 1B;

FIGS. 9A and 9B are cross-sectional views taken along, respectively, the line IXA-IXA and the line IXB-IXB of FIG. 8;

FIGS. 10A and 10B are cross-sectional views taken along, respectively, the line XA-XA and the line XB-XB of FIG. 8;

FIG. 11 is a plan view of a connector connecting structure of a second embodiment;

FIGS. 12A to 12D are conceptual diagrams illustrating states when a first connector and a second connector of FIG. 11 are connected;

FIG. 13 is a conceptual diagram illustrating a fitted state of a middle pair-of-connectors of FIG. 11;

FIG. 14 is a plan view of a modified example of the connector connecting structure of FIG. 11 (a fourth modified example);

FIG. 15 is a plan view of another modified example of the connector connecting structure of FIG. 11 (a fifth modified example);

FIG. 16 is a plan view of a connector connecting structure of a third embodiment; and

FIG. 17 is a conceptual diagram illustrating a fitted state of pairs-of-connectors at both ends of FIG. 16.

### DESCRIPTION OF THE PREFERRED EMBODIMENTS

Preferred embodiments of a connector connecting structure according to the present invention will be presented and described in detail below with reference to the accompanying drawings.

### First Embodiment

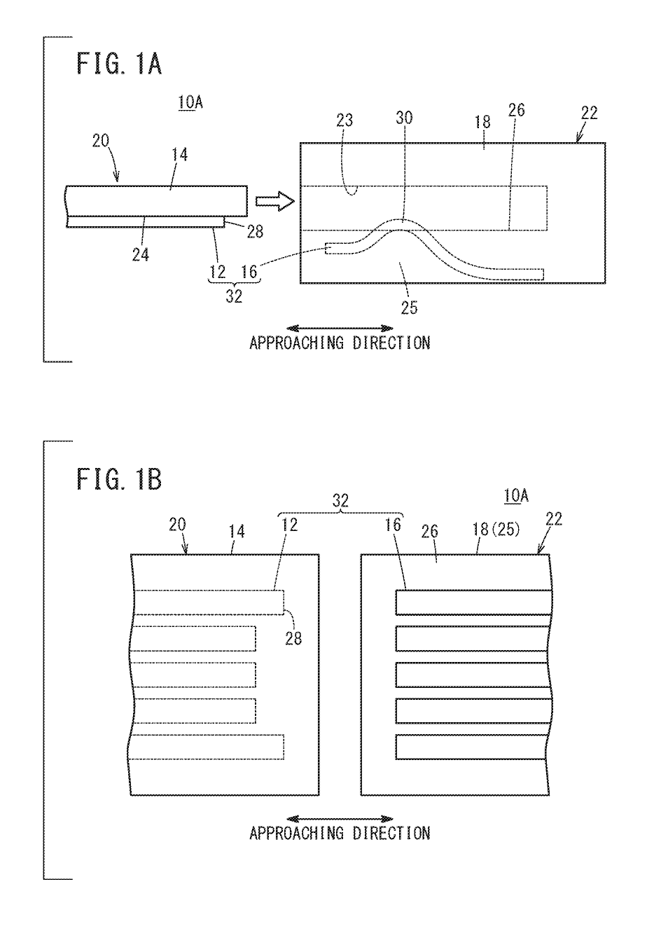

A connector connecting structure 10A of a first embodiment will be described with reference to FIGS. 1A to 3.

As shown in FIG. 1A, this connector connecting structure 10A has a first connector 20 and a second connector 22, and, by the first connector 20 being caused to relatively approach the second connector 22 in a fixed direction (an approaching direction), the first connector 20 and the second connector 22 are connected.

The first connector 20 has a plurality of first contacts 12 and a first support member 14 that supports the plurality of first contacts 12. As shown in FIGS. 1A and 1B, the first support member 14 is a planar substrate such as a printed circuit board. Note that in FIG. 1B, configurations of the first support member 14 and a support portion 25 of a second support member 18 that will be mentioned later, of the connector connecting structure 10A, are illustrated.

The plurality of first contacts 12 are plate-shaped conductive members that are disposed in parallel at fixed intervals in a direction perpendicular to the approaching direction and extend along the approaching direction, on one surface (a bottom surface 24) of the first support member 14. In this case, by a length of at least one first contact 12 in the approaching direction (which will also be referred to as an approaching-direction length of at least one first contact 12), of the plurality of first contacts 12 being made different from a length of another first contact 12 in the approaching direction, of the plurality of first contacts 12, positions in the approaching direction of tip portions 28 of the first contacts 12 on a second support member 18 side are changed. FIG. 1B illustrates the case where the approaching direction lengths of the two first contacts 12 at both ends in the direction perpendicular to the approaching direction, of the plurality of first contacts 12 are longer than the approaching direction lengths of the middle three first contacts 12, of the plurality of first contacts 12.

The second connector 22 has a plurality of second contacts 16 and the second support member 18 that supports the plurality of second contacts 16. The second support member 18 is a block-shaped member made of a resin, and the second support member 18 has therein a recess 23 of U-shaped cross section into which the first connector 20 can be inserted in the approaching direction. In the second support member 18, a portion on a bottom surface side forming the recess 23 is configured as the support portion 25 that supports and houses therein the plurality of second contacts 16.

The plurality of second contacts 16 are plate-shaped conductive members that are disposed in parallel at fixed intervals in a direction perpendicular to the approaching direction and extend along the approaching direction, in the support portion 25. The second contacts 16 have the same lengths in the approaching direction. The plurality of second contacts 16 have identical shapes and sizes. Each of the plurality of second contacts 16 has a curved portion 30 projecting upwardly (into the recess 23) from an upper surface 26 of the support portion 25. This curved portion 30 projects further upwardly than a lower surface of the first contact 12 of the first connector 20 inserted in the recess 23, and thereby contacts the first contact 12.

Therefore, when the first connector 20 is inserted in the recess 23, the tip portion 28 of the first contact 12 abuts on the curved portion 30 of the second contact 16 and the second contact 16 deforms by a pressing force (an inserting force) of the first connector 20, whereby the curved portion 30 moves downwardly. That is, a base end portion side of the second contact 16 is supported by the support portion 25 and the second contact 16 bends downwardly, whereby the curved portion 30 moves downwardly. As a result, the first connector 20 can be further inserted in the recess 23 of the second connector 22.

In this way, the connector connecting structure 10A is a connector connecting structure in which, by the male first connector 20 being inserted in the recess 23 of the female second connector 22, the first connector 20 and the second connector 22 are fitted together, whereby the plurality of first contacts 12 and the plurality of second contacts 16 are respectively connected.

In this connector connecting structure 10A, one pair-of-contacts 32 is configured by one first contact 12 and one second contact 16 that faces the one first contact 12 along the approaching direction and is connected to this one first contact 12. Next, a state of one pair-of-contacts 32 when the first connector 20 and the second connector 22 are connected, will be described in this connector connecting structure 10A.

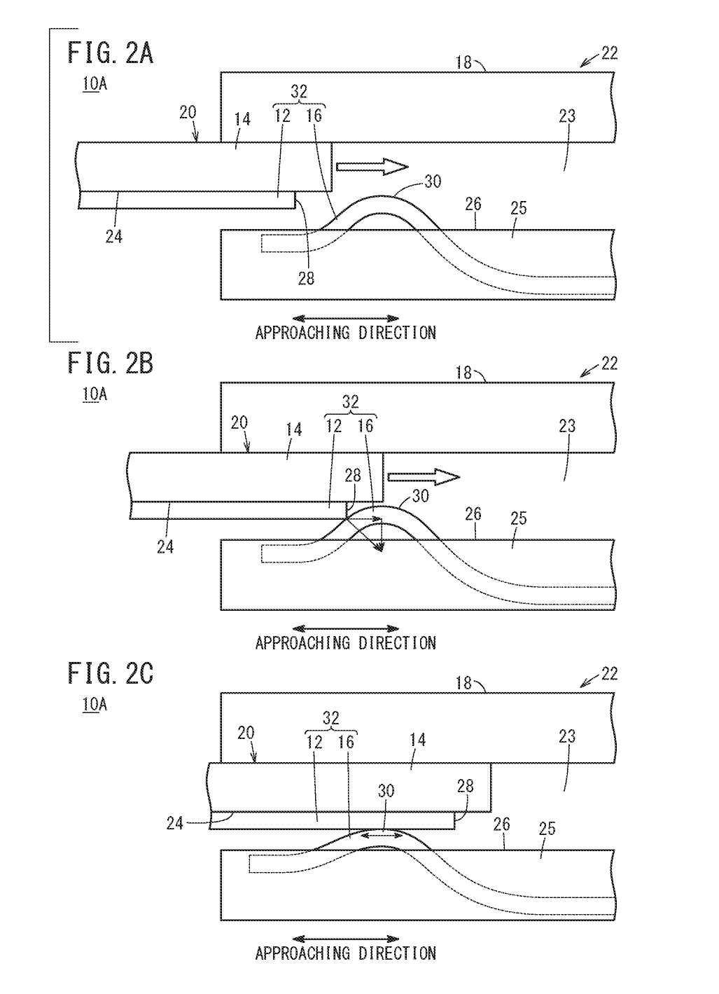

First, when, as shown in FIGS. 1A and 2A, the first connector 20 is moved (caused to approach) relatively along the approaching direction with respect to the second support member 18 of the second connector 22, and the first connector 20 is inserted in the recess 23 of the second support member 18, then, as shown in FIG. 2B, the tip portion 28 of the first contact 12 contacts the curved portion 30 of the second contact 16. Furthermore, by the tip portion 28 of the first contact 12 pressing relatively in the approaching direction the curved portion 30 of the second contact 16, the curved portion 30 moves downwardly, and a reaction force acting in an opposite direction to the approaching direction gets larger in the first contact 12 and the second contact 16. Therefore, the pressing force must be further strengthened to insert the first connector 20 into the second connector 22 relatively in the approaching direction.

Then, as shown in FIG. 2C, after the curved portion 30 moves downwardly to the lower surface of the first contact 12, the first contact 12 moves along the approaching direction while contacting the curved portion 30. Note that the curved portion 30 presses the first contact 12 upwardly by a returning force due to elastic deformation of the second contact 16, thereby securing a holding power by which connection of the first contact 12 and the second contact 16 is held. At this time, a force with which the curved portion 30 upwardly presses the first contact 12 occurs, so when the first contact 12 and the curved portion 30 are moving relatively, a frictional force (a reaction force) occurs between the first contact 12 and the curved portion 30. This frictional force is smaller than the reaction force occurring when the tip portion 28 of the first contact 12 and the curved portion 30 make contact.

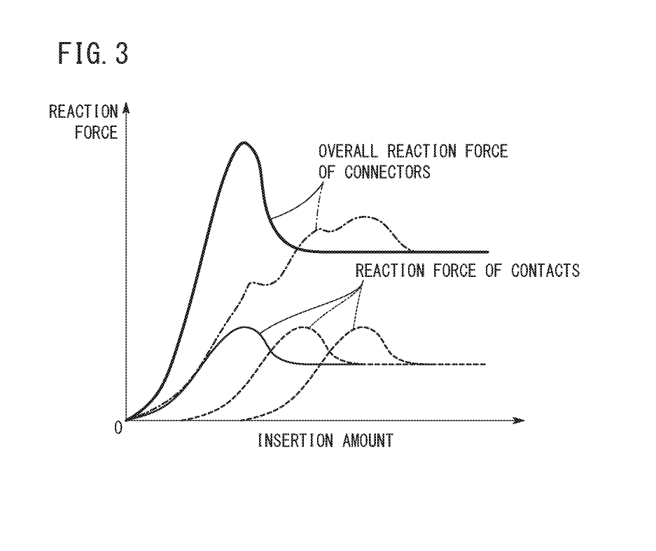

Now, in the case that when the first connector 20 has been pressed relatively toward the second connector 22 in the approaching direction, a timing at which the tip portion 28 of the first contact 12 and the curved portion 30 of the second contact 16 make contact is identical in each of a plurality of the pairs-of-contacts 32, the reaction force gets larger and an excessive pressing force (inserting force) becomes required, as shown by the thick solid line in FIG. 3. Accordingly, in the first embodiment, timings at which the tip portions 28 of the plurality of first contacts 12 and the curved portions 30 of the plurality of second contacts 16 make contact are staggered between each pair-of-contacts 32, as shown by the thin solid line and the broken line in FIG. 3, whereby lengths of the first contacts 12 in the approaching direction are changed.

In this way, in the connector connecting structure 10A of the first embodiment, by a simple configuration of staggering a position (an insertion amount of the first contact 12 with respect to the second contact 16) at which the reaction force exceeds a certain pressure (the holding force) by making different the lengths of the first contacts 12 in the approaching direction, between at least one pair-of-contacts 32 and another pair-of-contacts 32, in the plurality of pairs-of-contacts 32, the reaction force occurring during connection of the first contact 12 and the second contact 16 can be reduced as shown by the one dot-chain line in FIG. 3. Moreover, in each of the plurality of pairs-of-contacts 32, the first contact 12 and the second contact 16 are held by a certain holding force, so vibration resistance after fitting together of the first connector 20 and the second connector 22 can be improved.

### Modified Examples of First Embodiment

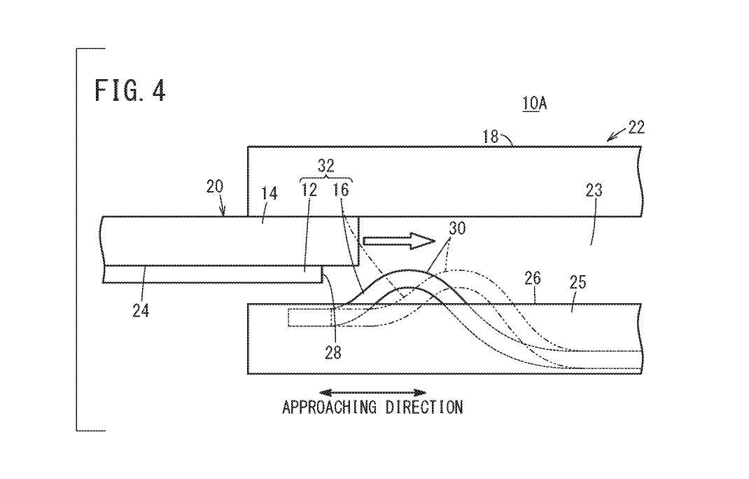

Next, modified examples of the connector connecting structure 10A of the first embodiment (first through third modified examples) will be described with reference to FIGS. 4 to 10B. Note that in the first through third modified examples, constitutional elements that are the same as those of the connector connecting structure 10A of FIGS. 1A to 3 will be assigned with the same reference symbols as those assigned in FIGS. 1A to 3, and detailed descriptions thereof will be omitted, the same applying also hereafter.

### First Modified Example

The first modified example of FIG. 4 differs from the configuration of FIGS. 1A to 3 in that in the plurality of pairs-of-contacts 32, while lengths of the first contacts 12 in the approaching direction are identical, regarding lengths of the second contacts 16 in the approaching direction, at least one pair-of-contacts 32 is made different from another pair-of-contacts 32. FIG. 4 illustrates as an example the case where the length of one second contact 16 in the approaching direction shown by the solid line and the broken line and the length of another second contact 16 in the approaching direction shown by the two dot-chain line differ from each other. Even in this case, the position (the insertion amount) at which the reaction force exceeds the certain pressure (the holding force) can be easily staggered, so similar advantages to those of the configuration of FIGS. 1A to 3 are obtained.

### Second Modified Example

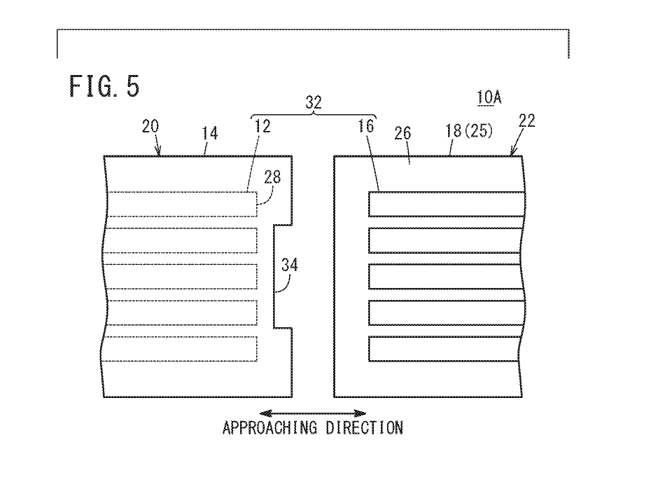

The second modified example of FIGS. 5 to 7B differs from the configurations of FIGS. 1A to 4 in being configured so that regarding a length of the first support member 14 in the approaching direction, at least one pair-of-contacts 32, from among the plurality of pairs-of-contacts 32, is made different from another pair-of-contacts 32. FIG. 5 illustrates as an example the case where, concerning the length of the first support member 14 in the approaching direction, by forming a recess 34 on a second support member 18 side of the first support member 14, the approaching-direction length of the first support member 14 in the two pairs-of-contacts 32 at both ends is longer than the approaching-direction length of the first support member 14 in the middle three pairs-of-contacts 32. Note that in the plurality of pairs-of-contacts 32, the lengths of the first contacts 12 in the approaching direction are identical, and the lengths of the second contacts 16 in the approaching direction are identical.

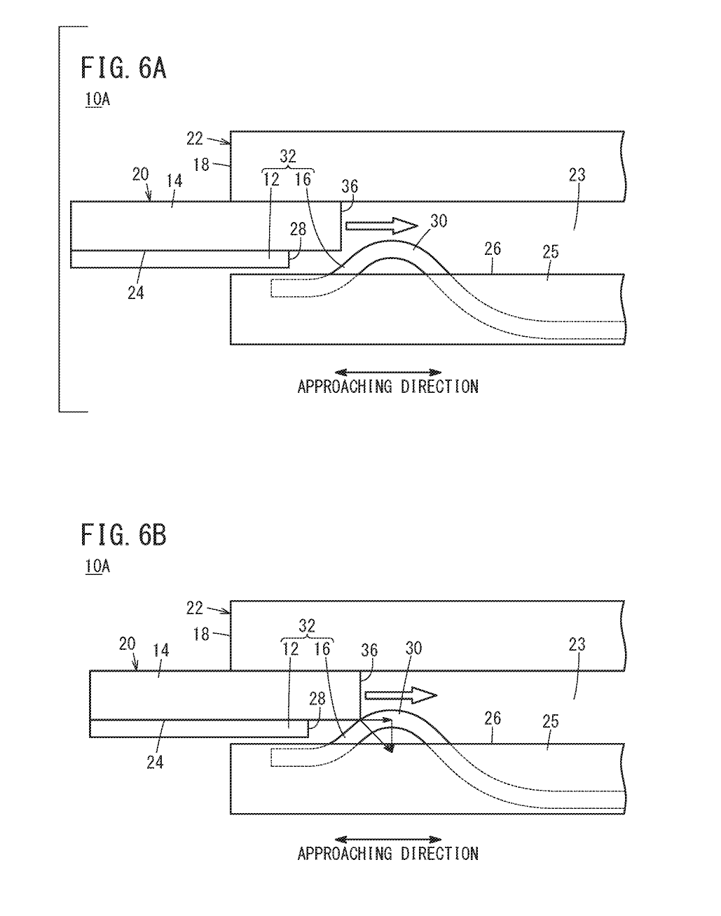

Moreover, in the second modified example, as shown in FIGS. 6A and 6B, the curved portion 30 projects from the upper surface 26 of the support portion 25 in such a manner that when the first connector 20 is inserted in the recess 23, a tip portion 36 of the first support member 14 on the second support member 18 side contacts the curved portion 30 of the second contact 16.

Therefore, when, as shown in FIG. 6A, the first connector 20 is inserted in the recess 23 of the second support member 18, then, as shown in FIG. 6B, the tip portion 36 of the first support member 14 contacts the curved portion 30 of the second contact 16. In this case, by the tip portion 36 of the first support member 14 pressing the curved portion 30 relatively in the approaching direction, the curved portion 30 moves downwardly, and a reaction force acting in an opposite direction to the approaching direction gets larger in the first support member 14 and the second contact 16.

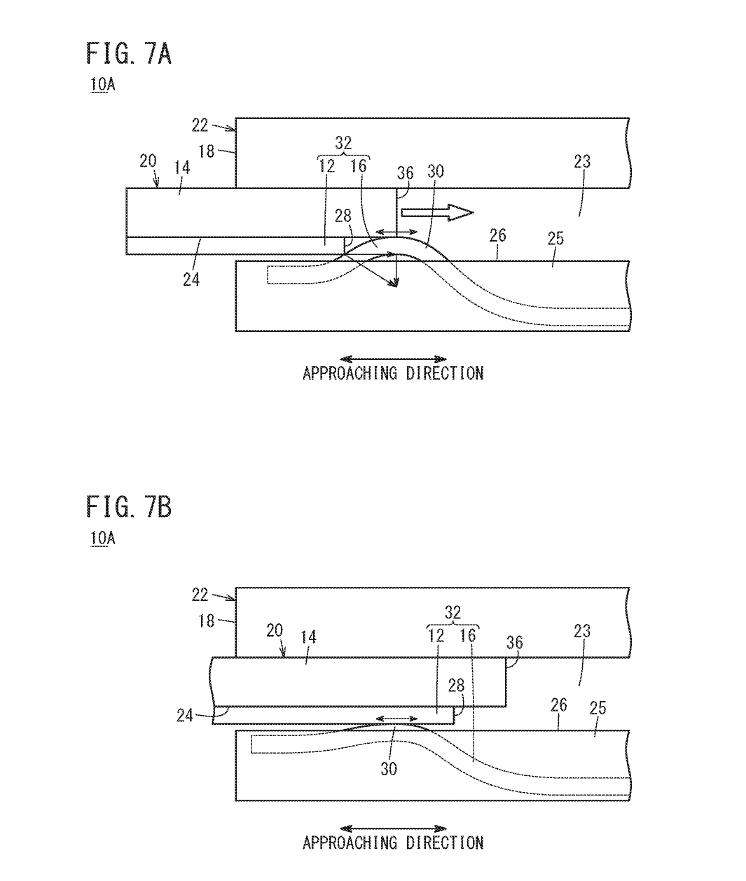

Accordingly, when the pressing force is further strengthened to insert the first connector 20 into the second connector 22 relatively in the approaching direction, then, as shown in FIG. 7A, the curved portion 30 moves downwardly to the bottom surface 24 of the first support member 14, and the first support member 14 moves along the approaching direction while contacting the curved portion 30. Note that the curved portion 30 upwardly presses the first support member 14 by a returning force due to elastic deformation of the second contact 16, thereby securing a holding force by which connection of the first support member 14 and the second contact 16 is held. At this time, a force with which the curved portion 30 upwardly presses the first support member 14 occurs, so when the first support member 14 and the curved portion 30 are moving relatively, a frictional force (a reaction force) occurs between the first support member 14 and the curved portion 30. This frictional force is smaller than the reaction force occurring when the tip portion 36 of the first support member 14 and the curved portion 30 make contact.

Then, when the first connector 20 is further inserted in the recess 23, the tip portion 28 of the first contact 12 contacts the curved portion 30. Furthermore, when the tip portion 28 of the first contact 12 presses relatively in the approaching direction the curved portion 30, and the curved portion 30 moves downwardly to the lower surface of the first contact 12, then, as shown in FIG. 7B, the first contact 12 moves along the approaching direction while contacting the curved portion 30. Note that operation when the tip portion 28 of the first contact 12 has contacted the curved portion 30 is similar to in the case of FIGS. 1A to 3, and hence a detailed description thereof will be omitted.

In the second modified example, the length of the first support member 14 in the approaching direction is made to vary between at least one pair-of-contacts 32 and another pair-of-contacts 32, in the plurality of pairs-of-contacts 32, whereby timings at which the tip portions 36 of the first support member 14 and the curved portions 30 of the plurality of second contacts 16 make contact are staggered between each pair-of-contacts 32, so similar advantages to those of the configuration of FIGS. 1A to 3 are obtained.

Note that although FIG. 5 illustrates the case where the length of the first support member 14 in the approaching direction has been made to vary, similar advantages are of course obtained even when the length of the second support member 18 in the approaching direction is made to vary between at least one pair-of-contacts 32 and another pair-of-contacts 32, in the plurality of pairs-of-contacts 32.

### Third Modified Example

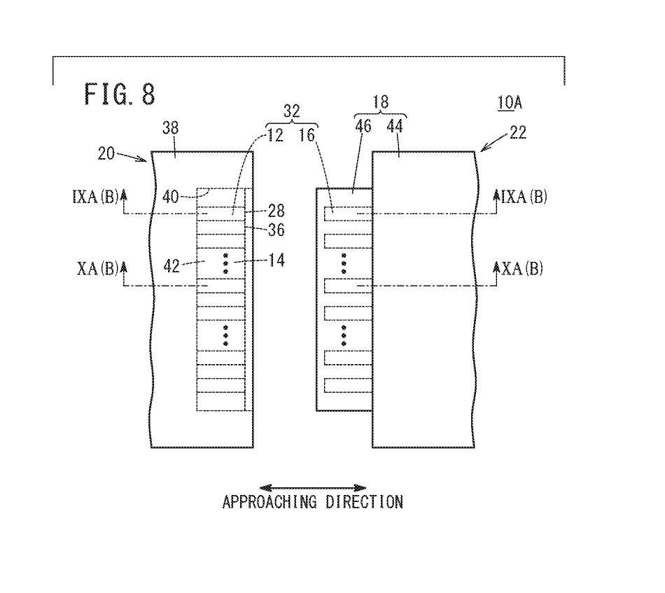

The third modified example of FIGS. 8 to 10B differs from the configurations of FIGS. 1A to 7B in that the number of connecting places (contact points) of the first contact 12 and the second contact 16 is made different between two pairs-of-contacts 32, of the plurality of pairs-of-contacts 32.

In the third modified example, the first connector 20 has a first housing 38. A recess 40 is formed on a second connector 22 side of the first housing 38, and the first support member 14 is provided within this recess 40. An upper surface 42 and the bottom surface 24 of the first support member 14 each have a plurality of the first contacts 12 disposed thereon.

On the other hand, the second connector 22 has a second housing 44. A projecting portion 46 capable of fitting in the recess 40 is formed on a first connector 20 side of the second housing 44. A recess 48 allowing insertion therein of the first support member 14 is formed within this projecting portion 46, and a plurality of the second contacts 16 are provided in this recess 48. Therefore, the second housing 44 and the projecting portion 46 form the second support member 18.

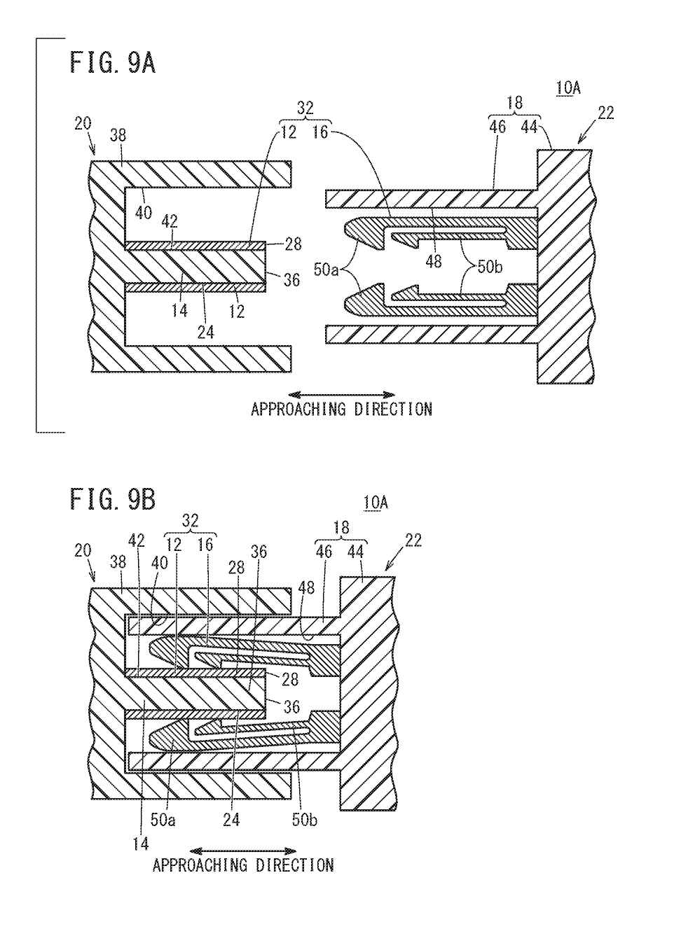

In this case, in at least the two pairs-of-contacts 32 at both ends, of the plurality of pairs-of-contacts 32, the first contact 12 and the second contact 16 are configured as vibration resistant type contacts making contact at multiple points (for example, two points). That is, as shown in FIGS. 9A and 9B, in each of the two pairs-of-contacts 32 at both ends, two second contacts 16 are disposed, one upwardly, and one downwardly, within the recess 48 of the projecting portion 46. Each of the second contacts 16 includes: a claw-shaped first contacting portion 50a that extends toward the first connector 20 side of the projecting portion 46; and a claw-shaped second contacting portion 50b that is disposed on an inner side of the first contacting portion 50a and is shorter than the first contacting portion 50a.

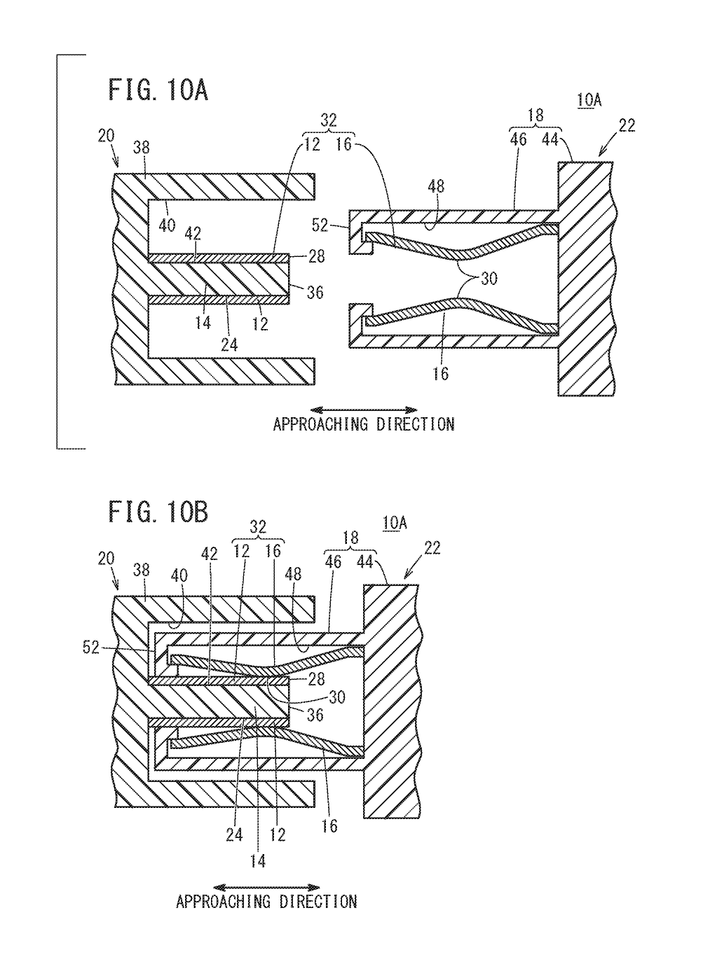

On the other hand, in each of middle pairs-of-contacts 32, of the plurality of pairs-of-contacts 32, the first contact 12 and the second contact 16 make contact at one point. That is, as shown in FIGS. 10A and 10B, in each of the middle pairs-of-contacts 32, an anchoring portion (hook portion) 52 extending inwardly from the projecting portion 46, is provided on the first connector 20 side of the projecting portion 46. In the recess 48 of the projecting portion 46, second contacts 16 are disposed, one upwardly, and one downwardly, between the second housing 44 and the anchoring portions 52. The second contact 16 has substantially the same shape as the second contacts 16 of FIGS. 1A, 2A to 2C, 4, and 6A to 7B.

Note that in the third modified example, a position in the approaching direction where the first contact 12 presses on the first contacting portion 50a, a position in the approaching direction where the first contact 12 presses on the second contacting portion 50b, and a position in the approaching direction where the first contact 12 presses on the curved portion 30, are staggered with respect to each other. Moreover, in the third modified example, by the first support member 14 being inserted in the recess 48 of the projecting portion 46, the male-side first contact 12 and the female-side second contact 16 are connected.

In this connector connecting structure 10A, when the first connector 20 is caused to relatively approach the second connector 22 in the approaching direction, and the projecting portion 46 of the second housing 44 is fitted in the recess 40 of the first housing 38, then, as shown in FIG. 9B, in each of the two pairs-of-contacts 32 at both ends, each of the upper and lower first contacts 12 is connected to the first contacting portion 50a and second contacting portion 50b of each of the upper and lower second contacts 16. Moreover, as shown in FIG. 10B, in each of the middle pairs-of-contacts 32, the upper and lower first contacts 12 are connected to the respective curved portions 30 of the upper and lower second contacts 16.

In this way, in the third modified example, the number of connecting places of the first contact 12 and the second contact 16 differs between two pairs-of-contacts 32, of the plurality of pairs-of-contacts 32, so vibration resistance after fitting together of the first connector 20 and the second connector 22 can be improved even more compared to when connection is made at one place in each of the plurality of pairs-of-contacts 32.

Specifically, in the third modified example, in at least the two pairs-of-contacts 32 at both ends, the first contact 12 and the second contact 16 are mutually contacted at multiple points, whereby contact pressure between the contacts is relatively high, while in each of the middle pairs-of-contacts 32 in the middle region, the first contact 12 and the second contact 16 are mutually contacted at one point, whereby contact pressure is relatively low. As a result, vibration resistance can be secured by a simple configuration.

Moreover, as shown in FIGS. 9A to 10B, by connecting places (contact positions) of the first contact 12 and the second contact 16 being staggered (differentiated) between the pairs-of-contacts 32 at both ends and the middle pairs-of-contacts 32, respective timings at which the tip portions 28 of the plurality of first contacts 12 make contact with the first contacting portions 50a, the second contacting portions 50b, and the curved portions 30 of the plurality of second contacts 16 are staggered in the pairs-of-contacts 32, so similar advantages to those of the configuration of FIGS. 1A to 3 are obtained. It goes without saying that the first contact 12 and the second contact 16 can be connected using the configurations of FIGS. 1A to 7B, in the third modified example as well.

### Second Embodiment

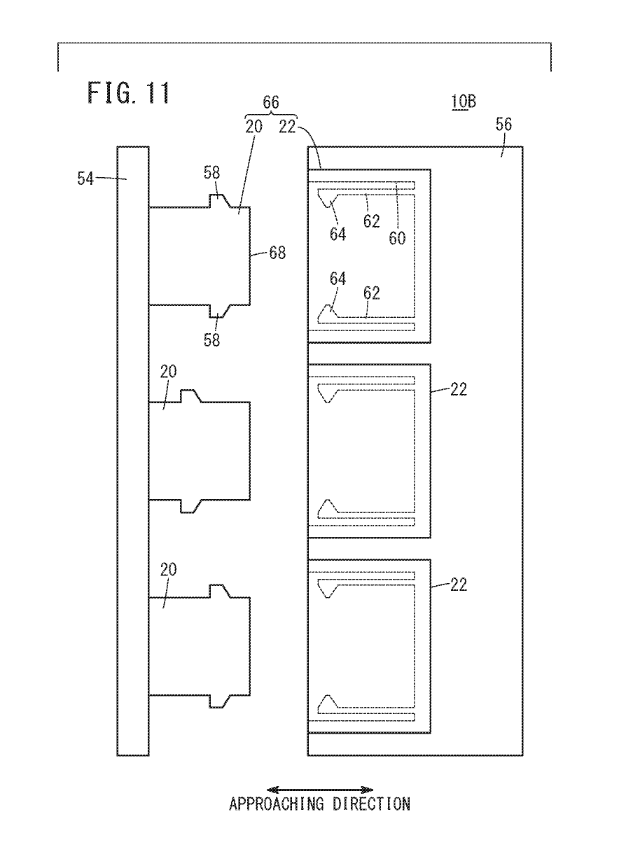

A connector connecting structure 10B of a second embodiment will be described with reference to FIGS. 11 to 13.

This connector connecting structure 10B includes: a first substrate 54 on which a plurality of the first connectors 20 are disposed; and a second substrate 56 disposed perpendicularly to the first substrate 54 and on which a plurality of the second connectors 22 are disposed, and, by the first substrate 54 and the second substrate 56 being caused to approach each other, the plurality of first connectors 20 and the plurality of second connectors 22 are respectively connected (fitted together).

The first substrate 54 is a planar substrate such as a printed circuit board, and has a plurality of the male first connectors 20 disposed in parallel at certain intervals along a direction perpendicular to the approaching direction, on one surface of the first substrate 54 on a second substrate 56 side.

In each of the plurality of first connectors 20, engaging projections 58 are respectively formed on the two side surfaces parallel to the approaching direction. In this case, a position in the approaching direction of the two engaging projections 58 in at least one first connector 20, of the plurality of first connectors 20, is made different from a position in the approaching direction of the two engaging projections 58 in another first connector 20. FIG. 11 illustrates the case where the position in the approaching direction of the two engaging projections 58 in each of the two first connectors 20 at both ends is closer to a second connector 22 side than the position in the approaching direction of the two engaging projections 58 in the middle first connector 20.

The second substrate 56 is a planar substrate such as a printed circuit board, and has a plurality of the female second connectors 22 disposed in parallel at certain intervals, on one surface (an upper surface) of the second substrate 56. That is, each of the plurality of second connectors 22 is provided on the upper surface of the second substrate 56 so as to extend in a direction (the approaching direction) facing the first connector 20.

The plurality of second connectors 22 have the same shape. That is, each of the plurality of second connectors 22 has a recess 60 in which the first connector 20 is housed. The recess 60 is provided with two engaging pieces 62 that extend toward the first connector 20. An engaging claw 64 that engages with the engaging projection 58 is formed in each of tips of the two engaging pieces 62.

In this connector connecting structure 10B, one pair-of-connectors 66 is configured by one first connector 20 and one second connector 22 that faces the one first connector 20 along the approaching direction and into which the one first connector 20 is fitted. Next, a state of one pair-of-connectors 66 when the plurality of first connectors 20 and the plurality of second connectors 22 are connected, will be described in this connector connecting structure 10B.

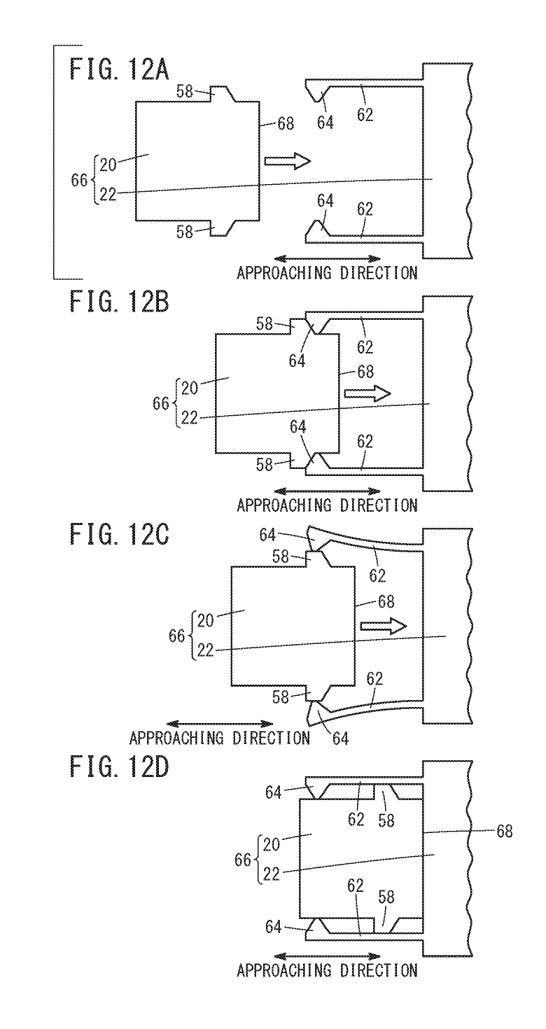

First, when, as shown in FIG. 12A, the first substrate 54 is relatively moved (caused to approach) toward the second substrate 56 along the approaching direction (refer to FIG. 11) and the first connector 20 is inserted in the recess 60 (refer to FIG. 11) of the second connector 22, then, as shown in FIG. 12B, the two engaging projections 58 of the first connector 20 respectively contact the engaging claws 64 of the two engaging pieces 62 of the second connector 22. Furthermore, as shown in FIG. 12C, by each of the engaging projections 58 pressing each of the engaging claws 64 relatively in the approaching direction, an engaging claw 64 side of each of the engaging pieces 62 bends in a direction perpendicular to the approaching direction (a direction in which the two engaging claws 64 separate away from each other), with a base end portion side of the engaging piece 62 as a fulcrum. In this case, a reaction force acting in an opposite direction to the approaching direction gets larger in the first connector 20 and the second connector 22. Therefore, the pressing force must be further strengthened to insert the first connector 20 into the second connector 22 relatively in the approaching direction.

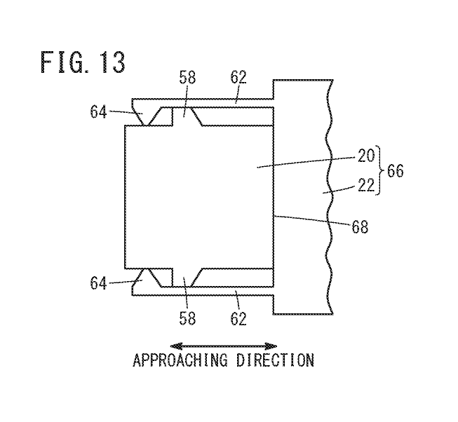

Then, when the first substrate 54 is moved in the approaching direction and the first connector 20 is further inserted, each of the engaging claws 64 is released from the pressing force, and each of the engaging pieces 62 returns to its initial position by a returning force due to elastic deformation. As a result of this, as shown in FIGS. 12D and 13, the first connector 20 moves along the approaching direction while the two side surfaces of the first connector 20 being in contact with the respective engaging claws 64, and the engaging projections 58 being in contact with the respective engaging pieces 62, and then a tip portion 68 of the first connector 20 abuts on an innermost side of the recess 60 (refer to FIG. 11) of the second connector 22. Note that FIG. 12D illustrates a state where the first connector 20 and the second connector 22 are mutually connected in one of the pairs-of-connectors 66 at both ends, and FIG. 13 illustrates a state where the first connector 20 and the second connector 22 are mutually connected in the middle pair-of-connectors 66.

In this case, due to contact between the two side surfaces of the first connector 20 and the engaging claws 64 and contact between the engaging projections 58 and the engaging pieces 62, there is secured a holding force by which connection (fitting together) of the first connector 20 and the second connector 22 is held. When the first connector 20 and the second connector 22 are moving relatively, frictional forces (reaction forces) respectively occur between the two side surfaces of the first connector 20 and each of the engaging claws 64 and between each of the engaging projections 58 and each of the engaging pieces 62. However, these frictional forces are smaller than the reaction force occurring when each of the engaging projections 58 and each of the engaging claws 64 make contact.

In this way, according to the connector connecting structure 10B of the second embodiment, a position in the approaching direction of the engaging projections 58 provided on the two side surfaces of each of the first connectors 20 is made different between at least one pair-of-connectors 66 and another pair-of-connectors 66, in the plurality of pairs-of-connectors 66. Accordingly, positions at which the reaction force exceeds a certain pressure (holding force), when the plurality of first connectors 20 and the plurality of second connectors 22 are respectively connected (fitted together), can be easily staggered (made different), similarly to in the connector connecting structure 10A of the first embodiment (refer to FIGS. 1A to 10B). As a result of this, the reaction force occurring during connection (during fitting together) of the plurality of first connectors 20 and the plurality of second connectors 22 can be reduced by a simple configuration.

Moreover, since the first connector 20 and the second connector 22 are held by a certain holding force for each of the plurality of pairs-of-connectors 66, vibration resistance after fitting together of the plurality of first connectors 20 and the plurality of second connectors 22 can be improved.

Furthermore, as shown in FIGS. 12D and 13, regarding a length that the first connector 20 is fitted to the second connector 22 (i.e., a distance between the two engaging claws 64 and the two engaging projections 58 after fitting together), the length in the two pairs-of-connectors 66 at both ends (refer to FIG. 12D) is longer than the length in the middle pair-of-connectors 66 (refer to FIG. 13). As a result, vibration resistance after fitting together of the plurality of first connectors 20 and the plurality of second connectors 22 can be certainly improved, and reliability can be increased.

Note that in the connector connecting structure 10B of the second embodiment, the third modified example of FIGS. 8 to 10B may be applied for each of the plurality of first connectors 20 and the plurality of second connectors 22, with the configuration of the first connector 20 and the second connector 22 shown in FIGS. 9A and 9B being adopted for the two pairs-of-connectors 66 at both ends, of the plurality of pairs-of-connectors 66, while the configuration of the first connector 20 and the second connector 22 shown in FIGS. 10A and 10B being adopted for the middle pair-of-connectors 66, of the plurality of pairs-of-connectors 66. This results in the number of connecting places (contact points) of the first contact 12 and the second contact 16 being made different between the two pairs-of-connectors 66 at both ends and the middle pair-of-connectors 66, so similar advantages to those of the third modified example are obtained, and vibration resistance after fitting together of the plurality of first connectors 20 and the plurality of second connectors 22 can be even further increased.

### Modified Examples of Second Embodiment

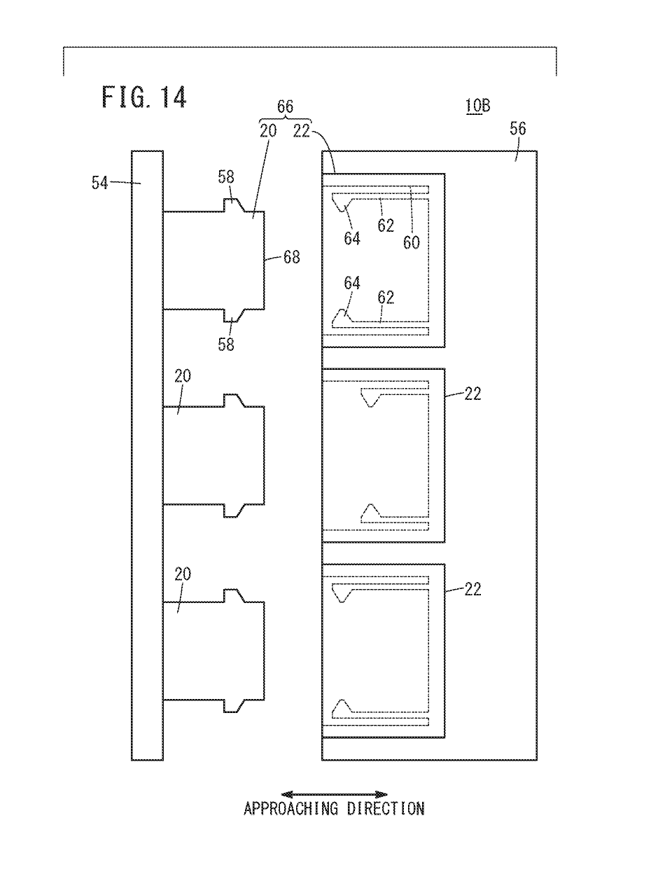

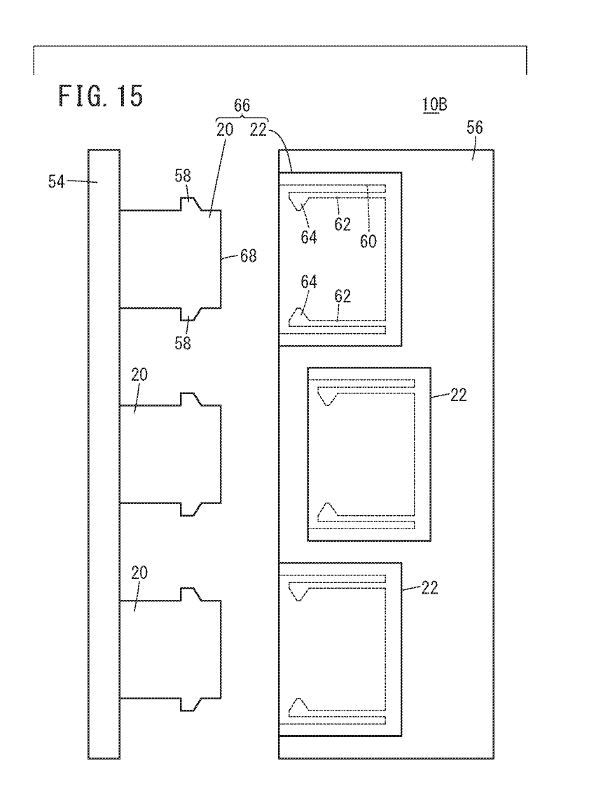

Next, modified examples of the connector connecting structure 10B of the second embodiment (fourth and fifth modified examples) will be described with reference to FIGS. 14 and 15.

### Fourth Modified Example

The fourth modified example of FIG. 14 differs from the configuration of FIGS. 11 to 13 in that while a position in the approaching direction of each of the engaging projections 58 is the same position for the plurality of first connectors 20, lengths of the two engaging pieces 62 in the approaching direction in the middle pair-of-connectors 66 are shorter than lengths of the two engaging pieces 62 in the approaching direction in the pairs-of-connectors 66 at both ends. Even in this case, the positions at which the reaction force exceeds a certain pressure (the holding force) when the plurality of first connectors 20 and the plurality of second connectors 22 are respectively connected (fitted together), can be easily staggered (made different from each other), and, regarding the length that the first connector 20 is fitted with respect to the second connector 22 when the plurality of first connectors 20 and the plurality of second connectors 22 are respectively connected (fitted together), the length in the two pairs-of-connectors 66 at both ends is longer than the length in the middle pair-of-connectors 66, so similar advantages to those of the configuration of FIGS. 11 to 13 are obtained.

### Fifth Modified Example

The fifth modified example of FIG. 15 differs from the configurations of FIGS. 11 to 14 in that while the positions of the engaging projections 58 in the approaching direction are the same position for the plurality of first connectors 20 and the lengths of the engaging pieces 62 in the approaching direction are the same length for the plurality of second connectors 22, the middle second connector 22 is provided in a place more separated from the first substrate 54 along the approaching direction, compared to where the second connectors 22 at both ends are provided. Even in this case, similar advantages to those of the configurations of FIGS. 11 to 14 are obtained.

### Third Embodiment

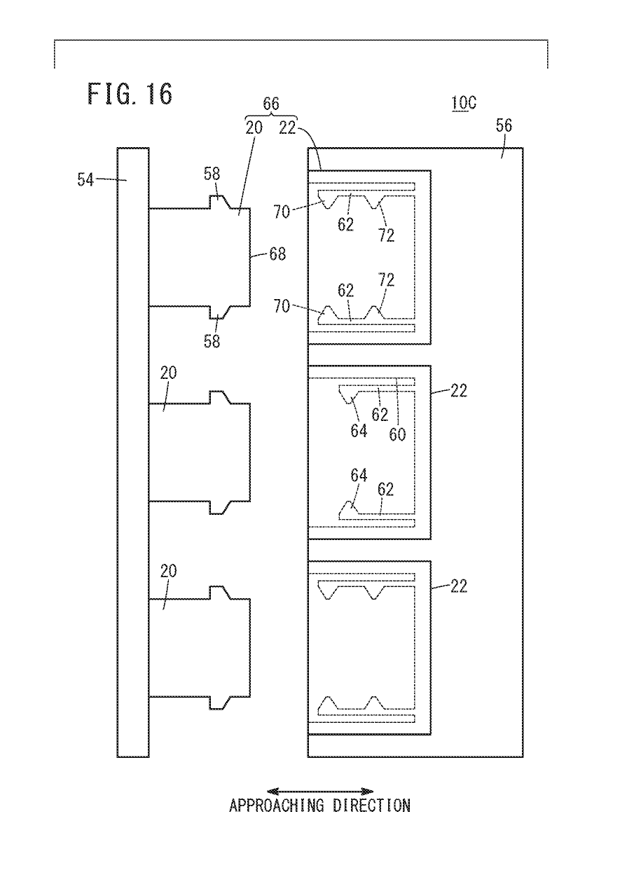

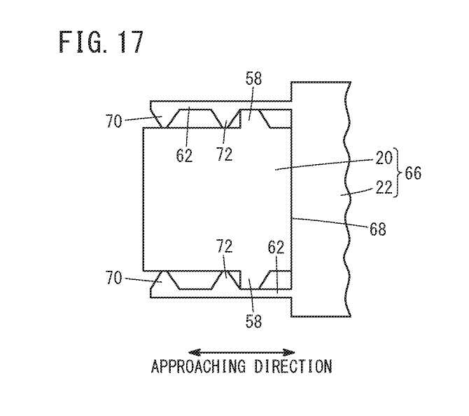

A connector connecting structure 10C of a third embodiment will be described with reference to FIGS. 16 and 17.

This connector connecting structure 10C differs from the connector connecting structure 10B of the second embodiment (refer to FIGS. 11 to 15) in that while the positions of the engaging projections 58 in the approaching direction are the same position for the plurality of first connectors 20, each of the engaging pieces 62 of the second connectors 22 at both ends includes: a first engaging claw 70 provided on a tip side of the engaging piece 62; and a second engaging claw 72 provided in a central portion of the engaging piece 62. In this case, a position of the first engaging claw 70 in the approaching direction, a position of the second engaging claw 72 in the approaching direction, and a position of the engaging claw 64 in the approaching direction are made different from each other.

In the third embodiment, in each of the two pairs-of-connectors 66 at both ends, when the plurality of first connectors 20 and the plurality of second connectors 22 are respectively connected (fitted together), the first connector 20 and the second connector 22 are connected in a state of multiple point contact by each of the first engaging claws 70, each of the second engaging claws 72, and each of the engaging projections 58. On the other hand, in the middle pair-of-connectors 66, when the plurality of first connectors 20 and the plurality of second connectors 22 are respectively connected (fitted together), the first connector 20 and the second connector 22 are connected in a state of multiple point contact by each of the engaging claws 64 and each of the engaging projections 58.

Therefore, the number of contact points between the first connector 20 and the second connector 22 in each of the two pairs-of-connectors 66 at both ends is greater than the number thereof in the middle pair-of-connectors 66. Consequently, a contact pressure (holding force) when the first connector 20 and the second connector 22 are connected (fitted together) becomes higher in each of the two pairs-of-connectors 66 at both ends than in the middle pair-of-connectors 66. As a result of this, vibration resistance after fitting together of the plurality of first connectors 20 and the plurality of second connectors 22 can be improved.

Moreover, as shown in FIGS. 16 and 17, the approaching-direction position (i.e., position in the approaching direction) of the first engaging claw 70 provided in each of the second connectors 22 at both ends, the approaching-direction position of the second engaging claw 72 provided in each of the second connectors 22 at both ends, and the approaching-direction position of the engaging claw 64 provided in the middle second connector 22 are staggered with respect to each other (i.e., made different from each other), and thus the positions at which the reaction force exceeds a certain pressure (the holding force) when the plurality of first connectors 20 and the plurality of second connectors 22 are respectively connected (fitted together), can be easily staggered, and the reaction force occurring when the plurality of first connectors 20 and the plurality of second connectors 22 are respectively connected (fitted together) can be reduced by a simple configuration, as in the case of the connector connecting structures 10A, 10B of the first and second embodiments (refer to FIGS. 1A to 15).

Note that the third modified example of FIGS. 8 to 10B may be applied also to the connector connecting structure 10C of the third embodiment, as in the case of the connector connecting structure 10B of the second embodiment. As a result, similar advantages to those of the third modified example are obtained, and vibration resistance after connection of the plurality of first connectors 20 and the plurality of second connectors 22 can be even further increased.

### Technical Concepts Obtained from Embodiments

Technical concepts understandable from the above-described embodiments will be described below.

In the connector connecting structure (10A) including: the first support member (14) configured to support the plurality of first contacts (12); and the second support member (18) configured to support the plurality of second contacts (16), the plurality of first contacts (12) and the plurality of second contacts (16) are respectively connected by the first support member (14) and the second support member (18) being caused to approach each other in the approaching direction. In a case where a pair of one of the first contacts (12) and one of the second contacts (16) that is connected to the one of the first contacts (12) is defined as a pair-of-contacts (32), when in each of a plurality of pairs-of-contacts (32) the first contact (12) is pressed against the second contact (16) relatively in the approaching direction and thereby connected to the second contact (16), a reaction force that acts along an opposite direction to the approaching direction occurs in the first contact (12) and the second contact (16) or in the first support member (14) and the second contact (16). Of the plurality of pairs-of-contacts (32), at least one pair-of-contacts (32) differs from another pair-of-contacts (32) regarding a position of the first contact (12) or the first support member (14) with respect to the second contact (16) in the approaching direction at which the reaction force exceeds a certain pressure.

As a result, the reaction force occurring during connection can be reduced by a simple configuration. Moreover, in each of the plurality of pairs-of-contacts (32), the first contact (12) and the second contact (16) are held by a certain pressure after connection, and thus vibration resistance after connection can be improved.

At least one pair-of-contacts (32) differs from another pair-of-contacts (32) regarding a length of the first contact (12) or the second contact (16) in the approaching direction.

As a result, positions at which the reaction force exceeds the certain pressure can be easily staggered (made different from each other), and the reaction force occurring during connection of the first contact (12) and the second contact (16) can be easily reduced.

At least one pair-of-contacts (32) differs from another pair-of-contacts (32) regarding a length of the first support member (14) or the second support member (18) in the approaching direction.

In this case also, positions at which the reaction force exceeds the certain pressure can be easily made different from each other, and thus the reaction force occurring during connection of the first contact (12) or first support member (14) and the second contact (16) can be easily reduced.

The number of contact points between the first contact (12) and the second contact (16) differs between two pairs-of-contacts (32), of the plurality of pairs-of-contacts (32).

As a result, vibration resistance after connection of the plurality of first contacts (12) and the plurality of second contacts (16) can be even further improved.

In the connector connecting structure (10B) including: the first substrate (54) with the plurality of first connectors (20) being disposed thereon; and the second substrate (56) with the plurality of second connectors (22) being disposed thereon, the plurality of first connectors (20) and the plurality of second connectors (22) are respectively fitted together by the first substrate (54) and the second substrate (56) being caused to approach each other in the approaching direction. In a case where a pair of one of the first connectors (20) and one of the second connectors (22) that is fitted to the one of the first connectors (20) is defined as a pair-of-connectors (66), when in each of a plurality of pairs-of-connectors (66) the first connector (20) is pressed against the second connector (22) relatively in the approaching direction and thereby fitted with respect to the second connector (22), a reaction force that acts along an opposite direction to the approaching direction occurs in the first connector (20) and the second connector (22). Of the plurality of pairs-of-connectors (66), at least one pair-of-connectors (66) differs from another pair-of-connectors (66) regarding a position of the first connector (20) with respect to the second connector (22) in the approaching direction at which the reaction force exceeds a certain pressure.

As a result, the reaction force occurring during connection (fitting together) can be reduced by a simple configuration. Moreover, in each of the plurality of pairs-of-connectors (66), the first connector (20) and the second connector (22) are held by a certain pressure after connection, and thus vibration resistance after connection can be improved.

At least one pair-of-connectors (66) differs from another pair-of-connectors (66) regarding a length that the first connector (20) is fitted with respect to the second connector (22).

As a result, positions at which the reaction force exceeds the certain pressure can be easily staggered, vibration resistance after connection of the plurality of first connectors (20) and the plurality of second connectors (22) can be certainly improved, and reliability can be increased.

In the connector connecting structure (10C) including: the first substrate (54) with the plurality of first connectors (20) being disposed in parallel thereon; and the second substrate (56) with the plurality of second connectors (22) being disposed in parallel thereon, the plurality of first connectors (20) and the plurality of second connectors (22) are respectively fitted together by the first substrate (54) and the second substrate (56) being caused to approach each other in the approaching direction. In a case where a pair of one of the first connectors (20) and one of the second connectors (22) that is fitted with respect to the one of the first connectors (20) is defined as a pair-of-connectors (66), and a contact pressure when the first connector (20) and the second connector (22) are fitted together differs between two pairs-of-connectors (66), of the plurality of the pairs-of-connectors (66).

In this case also, the reaction force occurring during connection (fitting together) can be reduced by a simple configuration. Moreover, vibration resistance after connection of the plurality of first connectors (20) and the plurality of second connectors (22) can be improved.

Each of the plurality of first connectors (20) and the plurality of second connectors (22) has a contact (12, 16), and the number of contact points between the contact (12) of the first connector (20) and the contact (16) of the second connector (22) differs between two pairs-of-connectors (66), of the plurality of pairs-of-connectors (66).

As a result, vibration resistance after connection of the plurality of first connectors (20) and the plurality of second connectors (22) can be even further improved.

The present invention is not particularly limited to the embodiments described above, and various modified examples are possible without departing from the essence and gist of the present invention.

What is claimed is:

1. A connector connecting structure comprising:
a first support member configured to support a plurality of first contacts; and
a second support member configured to support a plurality of second contacts,
wherein the plurality of first contacts and the plurality of second contacts are respectively connected by the first support member and the second support member being caused to approach each other in an approaching direction,
in a case where a pair of one of the first contacts and one of the second contacts that is connected to the one of the first contacts is defined as a pair-of-contacts, when in each of a plurality of pairs-of-contacts the first contact is pressed against the second contact relatively in the approaching direction and thereby connected to the second contact, a reaction force that acts along an opposite direction to the approaching direction occurs in the first contact and the second contact or in the first support member and the second contact, and
of the plurality of pairs-of-contacts, at least one pair-of-contacts differs from another pair-of-contacts regarding a position of the first contact or the first support member with respect to the second contact in the approaching direction at which the reaction force exceeds a certain pressure.

2. The connector connecting structure according to claim 1, wherein at least one of the pairs-of-contacts differs from another pair-of-contacts regarding a length of the first contact or the second contact in the approaching direction.

3. The connector connecting structure according to claim 1, wherein at least one of the pairs-of-contacts differs from another pair-of-contacts regarding a length of the first support member or the second support member in the approaching direction.

4. The connector connecting structure according to claim 1, wherein a number of contact points between the first contact and the second contact differs between two pairs-of-contacts, of the plurality of pairs-of-contacts.

5. A connector connecting structure comprising:
a first substrate with a plurality of first connectors being disposed thereon; and
a second substrate with a plurality of second connectors being disposed thereon,
wherein the plurality of first connectors and the plurality of second connectors are respectively fitted together by the first substrate and the second substrate being caused to approach each other in an approaching direction,
in a case where a pair of one of the first connectors and one of the second connectors that is fitted with respect to the one of the first connectors is defined as a pair-of-connectors, when in each of a plurality of pairs-of-connectors the first connector is pressed against the second connector relatively in the approaching direction and thereby fitted with respect to the second connector, a reaction force that acts along an opposite direction to the approaching direction occurs in the first connector and the second connector, and
of the plurality of pairs-of-connectors, at least one pair-of-connectors differs from another pair-of-connectors regarding a position of the first connector with respect to the second connector in the approaching direction at which the reaction force exceeds a certain pressure.

6. The connector connecting structure according to claim 5, wherein at least one of the pairs-of-connectors differs from another pair-of-connectors regarding a length that the first connector is fitted with respect to the second connector.

7. A connector connecting structure comprising:
a first substrate with a plurality of first connectors being disposed in parallel thereon; and
a second substrate with a plurality of second connectors being disposed in parallel thereon,
wherein the plurality of first connectors and the plurality of second connectors are respectively fitted together by the first substrate and the second substrate being caused to approach each other in an approaching direction, and
in a case where a pair of one of the first connectors and one of the second connectors that is fitted with respect to the one of the first connectors is defined as a pair-of-connectors, a contact pressure when the first connector and the second connector are fitted together differs between two pairs-of-connectors, of a plurality of the pairs-of-connectors.

8. The connector connecting structure according to claim 5, wherein
each of the plurality of first connectors and the plurality of second connectors has a contact, and
a number of contact points between the contact of the first connector and the contact of the second connector differs between two pairs-of-connectors, of the plurality of pairs-of-connectors.
